(19) United States
(12) Patent Application Publication
(10) Pub. No.: US 2003/0048989 A1
(43) Pub. Date: Mar. 13, 2003

(54) Planar lightwave circuit and method for compensating center wavelength of optical transmission of planar lightwave circuit

(75) Inventors: Kazuhisa Kashihara, Tokyo (JP); Kazutaka Nara, Tokyo (JP); Kanji Tanaka, Tokyo (JP); Isao Oyama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd., Tokyo (JP)

(21) Appl. No.: 10/132,518

(22) Filed: Apr. 26, 2002

(30) Foreign Application Priority Data
Sep. 7, 2001 (JP) 2001-271902

(51) Int. Cl. G02B 6/34; G02B 6/10; G02B 6/12

(52) U.S. Cl. 385/37; 385/14; 385/129

(57) ABSTRACT

A method for compensating a center wavelength of optical transmission of a planar lightwave circuit includes heating the planar lightwave circuit from a first set temperature to a second set temperature. The first set temperature is at least approximately a room temperature and at most approximately 500° C. The second set temperature is at least approximately 500° C. and at most approximately 900° C. The planar lightwave circuit is maintained at the second set temperature for a predetermined retention time. The planar lightwave circuit is cooled from the second set temperature to a third set temperature. The third set temperature is at least approximately a room temperature and at most approximately 500° C.

### CROSS-REFERENCE TO RELATED APPLICATIONS

The present application claims priority to Japanese Patent Application No. 2001-271902, filed Sep. 7, 2001. The contents of that application are incorporated herein by reference in their entirety.

### BACKGROUND OF THE INVENTION

1. Field of the Invention

The present invention relates to a planar lightwave circuit and a method for compensating a center wavelength of optical transmission of a planar lightwave circuit.

2. Discussion of the Background

Recently, in optical communications, research and development of the optical wavelength division multiplexing transmission has been conducted actively for the way to dramatically increase the transmission capacity thereof, and practical applications have been proceeding. The optical wavelength division multiplexing transmission is that a plurality of lights having wavelengths different from each other are multiplexed and transmitted, for example. In order to demultiplex the multiplexed and transmitted light on the light receiving side, the aforementioned optical wavelength division multiplexing transmission system needs an optical component which transmits lights having only predetermined wavelengths.

As the optical transmission device described above, a planar lightwave circuit (PLC), described as follows, has been adopted. The planar lightwave circuit includes, for example, an arrayed waveguide grating (AWG), a Mach-Zehnder interferometer (MZI), a ring resonator (RI) and the like.

The wavelength multiplexing transmission system requires a planar lightwave circuit such as the arrayed waveguide grating having a high wavelength accuracy. In the planar lightwave circuit such as the arrayed waveguide grating, however, since the center wavelengths of the optical transmission at the predetermined temperature vary due to errors occurred during the manufacturing process or the like, it has been difficult to improve the yield or manufacturing yield while satisfying the required wavelength accuracy.

As one of methods for compensating the center wavelength of the optical transmission in the planar lightwave circuit such as the arrayed waveguide grating, Japanese Unexamined Patent Publication (KOKAI) No. 11-341146 discloses a method for compensating the center wavelength of the optical transmission in the silica-based planar lightwave circuit device. The contents of this application are incorporated herein by reference in their entirety.

In this method, the center wavelength of the optical transmission of the silica-based planar lightwave circuit device is compensated by heat treatment, and for example, the planar lightwave circuit is placed in a heat treat furnace at 700° C. to apply the heat treatment thereto for 96 hours. In this method, it has been disposed that the center wavelength of the optical transmission in the planar lightwave circuit can be shifted to the longer wavelength side by about 0.11 nm.

However, this method may not be sufficient for compensating the center wavelength of the optical transmission.

Also, in this method, it takes time exponentially with respect to the compensation amount of the center wavelength of the optical transmission. Accordingly, it requires four days to shift the center wavelength of the optical transmission by about 0.1 nm. In case the compensation amount exceeds 0.1 nm, the method is not practical.

### SUMMARY OF THE INVENTION

According to one aspect of the present invention, a method for compensating a center wavelength of optical transmission of a planar lightwave circuit includes heating the planar lightwave circuit from a first set temperature to a second set temperature. The first set temperature is at least approximately a room temperature and at most approximately 500° C. The second set temperature is at least approximately 500° C. and at most approximately 900° C. The planar lightwave circuit is maintained at the second set temperature for a predetermined retention time. The planar lightwave circuit is cooled from the second set temperature to a third set temperature. The third set temperature is at least approximately a room temperature and at most approximately 500° C.

According to another aspect of the present invention, a method for manufacturing a planar lightwave circuit includes forming a waveguide forming region on a substrate and heating the waveguide forming region and the substrate from a first set temperature to a second set temperature. The first set temperature is at least approximately a room temperature and at most approximately 500° C. The second set temperature is at least approximately 500° C. and at most approximately 900° C. The waveguide forming region and the substrate are maintained at the second set temperature for a predetermined retention time. The waveguide forming region and the substrate are cooled from the second set temperature to a third set temperature. The third set temperature is at least approximately a room temperature and at most approximately 500° C.

According to yet another aspect of the present invention, a planar lightwave circuit includes a substrate and a waveguide forming region formed on the substrate. The substrate and the waveguide forming region are constructed such that the substrate and the waveguide forming region are heated from a first set temperature to a second set temperature, maintained at the second set temperature for a predetermined retention time, and cooled from the second set temperature to a third set temperature. The first set temperature is at least approximately a room temperature and at most approximately 500° C. The second set temperature is at least approximately 500° C. and at most approximately 900° C. The third set temperature is at least approximately a room temperature and at most approximately 500° C.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram showing a planar lightwave circuit according to an embodiment of the present invention;

FIG. 2 is a graph showing examples of heat treatment temperature patterns for compensating a center wavelength of an optical transmission of the planar lightwave circuit according to an embodiment of the present invention;

FIG. 3 is a graph showing an example of a heat treatment temperature pattern for compensating the center wavelength of the optical transmission of the planar lightwave circuit according to an embodiment of the present invention;

FIG. 4 is a graph showing a relationship between a second set temperature and a difference of the center wavelengths of the optical transmission before and after the heat treatment;

FIG. 5 is a graph showing a relationship between a retention time and a difference of the center wavelengths of the optical transmission before and after the heat treatment;

FIG. 6 is a graph showing an example of a heat treatment temperature pattern for compensating the center wavelength of the optical transmission of the planar lightwave circuit according to another embodiment of the present invention;

FIG. 7 is an explanatory diagram schematically showing a structure of a Mach-Zehnder interferometer; and

FIG. 8 is an explanatory diagram schematically showing a structure of a ring resonator.

### DESCRIPTION OF THE EMBODIMENTS

The embodiments will now be described with reference to the accompanying drawings, wherein like reference numerals designate corresponding or identical elements throughout the various drawings.

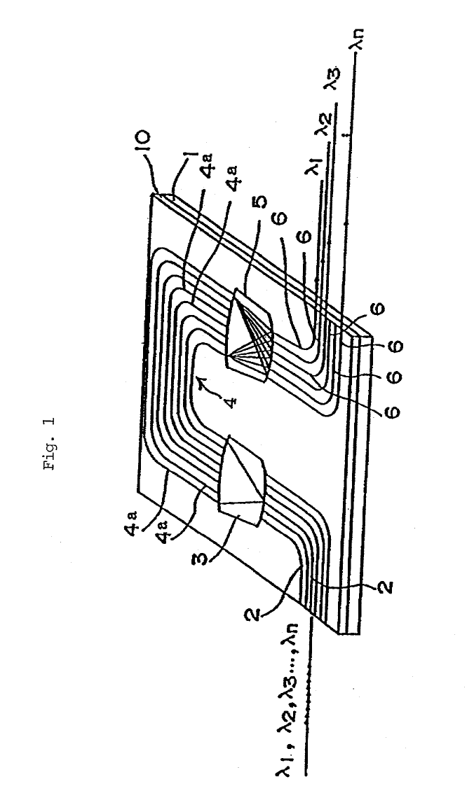

FIG. 1 shows a schematic diagram of an embodiment of the planar lightwave circuit according to the present invention. As shown in FIG. 1, the planar lightwave circuit of the embodiment is an arrayed waveguide grating. The arrayed waveguide grating is formed by forming a silica-based glass waveguide forming region 10 on a substrate 1 made of silicon or the like. The waveguide pattern of the arrayed waveguide grating includes at least one optical input waveguide (at least one first optical waveguide) 2 arranged side by side, a first slab waveguide 3 connected to the outgoing side of the optical input waveguides 2, an arrayed waveguide 4 connected to the outgoing side of the first slab waveguide 3, a second slab waveguide 5 connected to the outgoing side of the arrayed waveguide 4, and a plurality of optical output waveguides (second optical waveguides) 6 which are arranged side by side and which are connected to the outgoing side of the second slab waveguide 5.

The arrayed waveguide 4 is provided for propagating lights which have been led from the first slab waveguide 3. The arrayed waveguide 4 includes a plurality of channel waveguides (4a) arranged side by side. Lengths of channel waveguides (4a) adjacent to each other are different from each other by a predetermined length (ΔL).

The optical output waveguides 6 are provided corresponding to the number of the signal lights which have wavelengths different from each other and which are multiplexed or into which a signal light is demultiplexed by the arrayed waveguide grating. Generally, channel waveguides (4a) are provided in multiple such as, for example, one hundred. In FIG. 1, however, the number of the channel waveguides (4a), the number of the optical output waveguide 6, and the number of the optical input waveguides 2 are schematically shown to simplify the drawing, respectively.

Each optical input waveguide 2 is connected to an optical fiber (not shown) on the transmitting side, for example, to lead the multiplexed light therein. The light passing through one of the optical input waveguides 2 and being led to the first slab waveguide 3 is diffracted by the diffraction effect thereof to enter the arrayed waveguide 4, so that the light is propagated in the arrayed waveguide 4.

The lights propagated in the arrayed waveguide 4 reach the second slab waveguide 5 and are focused at the optical output waveguides 6 to be outputted. While, since the lengths of all of the channel waveguides 4a in the arrayed waveguide 4 are different from each other, after the lights are propagated in the arrayed waveguide 4, phases of the respective lights are shifted. Accordingly, wavefronts of the focused lights are tilted in accordance with the shifted amount, and the positions at which the lights are focused are determined by the tilted angle.

Therefore, the positions where the lights having the different wavelengths are focused are different from each other. Accordingly, by forming the optical output waveguides 6 at respective light focused positions, the lights having the different wavelengths can be outputted from the different optical output waveguides 6 at every wavelength.

In other words, the arrayed waveguide grating has an optical demultiplexing function for demultiplexing a multiplexed light which is inputted from the optical input waveguides 2 and has a plurality of wavelengths different from each other. A center wavelength of the demulplexed light is in proportion to the length difference (ΔL) of the adjacent channel waveguides (4a) of the arrayed waveguide 4 and an effective refractive index (n_{c}) of the channel waveguides (4a).

Since the arrayed waveguide grating has the characteristics described above, the arrayed waveguide grating can be used as an optical component for demultiplexing a light in the optical wavelength division multiplexing transmission. As shown in FIG. 1, for example, when the multiplexed light having the wavelengths λ1, λ2, λ3, . . . λn (n is an integer of two or greater) are inputted from one of the optical input waveguides 2, this light is diffracted at the first slab waveguide 3 to reach the arrayed waveguide 4. Then, the lights pass through the second slab waveguide 5, and focused at the different positions in accordance with the wavelengths as described above, to thereby enter the different optical output waveguides 6. Then, the lights pass through the respective optical output waveguides 6, and outputted from the outgoing ends of the optical output waveguides 6.

Then, optical fibers (not shown) for outputting lights are connected to the outgoing ends of the respective optical output waveguides 6, so that the lights having the respective wavelengths are removed through the optical fibers. Incidentally, when the optical fibers are connected to the respective optical output waveguides 6 or the aforementioned optical input waveguides 2, an optical fiber array is provided. In the optical fiber array, connecting end surfaces for the optical fibers are arranged in one-dimensional array form. The optical fiber array is connected to connecting end surfaces of the optical output waveguides 6 or the optical input waveguides 2, to thereby connect the optical fibers and the optical output waveguides 6 or the optical input waveguides 2.

In the arrayed waveguide grating described above, the optical transmission characteristics (wavelength characteristics of the transmitted light intensity of the arrayed waveguide grating) of the lights outputted from the respective optical output waveguides 6 exhibits such optical transmission characteristics that optical transmittance are reduced as the respective wavelengths are shifted from the corresponding center wavelengths (λ1, λ2, λ3, . . . λn, for example) of the optical transmissions.

The center wavelength (λ₀) of optical transmission in the arrayed waveguide grating is determined by the effective refractive index (n_{c}) of the arrayed waveguide 4, the length difference (ΔL) of the adjacent channel waveguides (4a), and a diffraction order (m). The center wavelength (λ₀) of the arrayed waveguide grating is calculated by the following expression (1).

(λ₀)=(n_{c})×(ΔL)/(m) (1)

Also, since the arrayed waveguide grating utilizes the principle of reciprocity (reversibility) of the optical circuit, the arrayed waveguide grating has the function of the optical demultiplexer as well as the function of the optical multiplexer. In other words, on the contrary to the example in FIG. 1, when a plurality of lights having the wavelengths different from each other are inputted from the respective optical output waveguides 6, these lights pass through the second slab waveguide 5, the arrayed waveguide 4, and the first slab waveguide 3, and go out from one of the optical input waveguides 2. In this case, the lights are multiplexed.

In this type of the arrayed waveguide grating, as described above, the wavelength resolution of the arrayed waveguide grating is in proportion to the length difference (ΔL) of the respective channel waveguides (4a) of the arrayed waveguide 4. Accordingly, by increasing the length difference (ΔL), multiplexing lights and demultiplexing a light with a narrow wavelength spacing can be achieved, that has not been achieved in the conventional multiplexer/demultiplexer. Therefore, the arrayed waveguide grating can exhibit the function for multiplexing signal lights and demultiplexing a signal light, which is required for achieving the high-density optical wavelength division multiplexing transmission, that is, the function for demultiplexing a signal light and multiplexing a plurality of signal lights having a wavelength spacing of at most approximately 1 nm.

When the planar lightwave circuit, such as the arrayed waveguide grating, the Mach-Zehnder interferometer, and the ring resonator, is manufactured, firstly, an under cladding film and a core film are formed in order on a silicon substrate by using the flame hydrolysis deposition method, for example. Thereafter, by using the photolithography and the reactive ion etching method, a pattern having the respective waveguide patterns is transferred to the core film. Then, an over cladding film is formed by using the flame hydrolysis deposition method again.

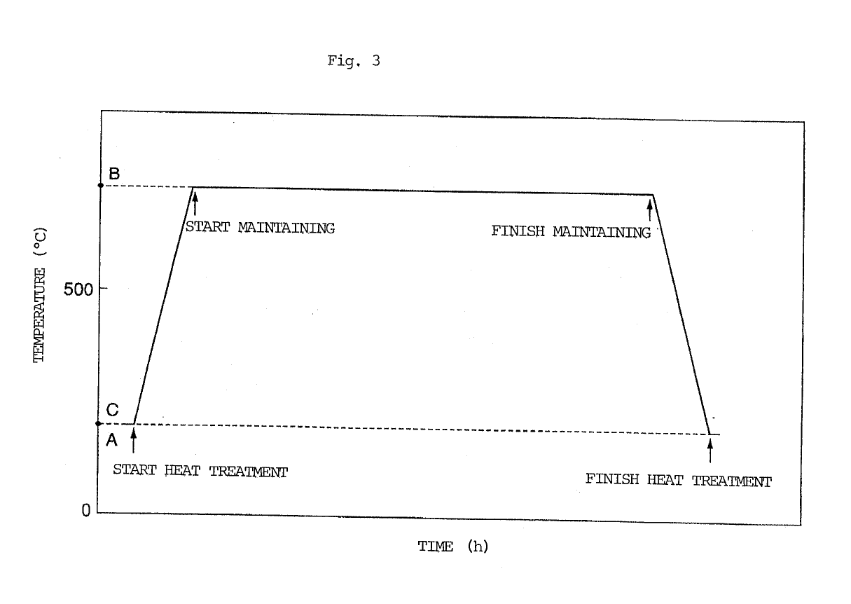

The inventors of the present invention have been conducted various studies to carry out the precise compensation of the center wavelength of the optical transmission in the planar lightwave circuit, such as the arrayed waveguide grating, in the possibly shortest time. As a result, the inventors found a heat treatment in which the compensation of the center wavelength of the optical transmission can be effectively carried out. Namely, referring to FIG. 3, after the temperature is increased from a first set temperature (A in FIG. 3), which is at least approximately a room temperature and at most approximately 500° C., to a second set temperature (B in FIG. 3), which is at least approximately 500° C. and at most approximately 900° C., the temperature is maintained at the second set temperature for a predetermined retention time.

Also, as shown in FIG. 3, the inventors considered that after the aforementioned heat treatment, the temperature is lowered to a third set temperature (C in FIG. 3), which is at least approximately a room temperature and at most approximately 500° C., to thereby safely remove the planar lightwave circuit.

Incidentally, the above studies and experiments were conducted by using the arrayed waveguide grating as the planar lightwave circuit, and the first set temperature and the third set temperature were both set at about 200° C. Then, by maintaining the second temperature in the range of at least approximately 500° C. and at most approximately 900° C. for about 24 hours, the center wavelength of the optical transmission of the arrayed waveguide grating was adjusted to the longer wavelength side by at least about 0.1 nm. Especially, if the second set temperature is set at least approximately 600° C. and at most approximately 850° C., the center wavelength of the optical transmission in the arrayed waveguide grating was adjusted to the longer wavelength side by at least about 0.15 nm.

Also, in the above experiments, the present inventors found that the compensation amount of the center wavelength of the optical transmission was adjusted by adjusting the retention time during which the planar lightwave circuit is kept in the second set temperature.

Incidentally, in the above experiments, the temperature was increased in a rate of about 5° C./min from the first set temperature to the second set temperature, and decreased in a rate of about 5° C./min from the second set temperature to the third set temperature.

According to the embodiment of the present invention, the center wavelength of the optical transmission in the planar lightwave circuit such as the arrayed waveguide grating can be adjusted to the longer wavelength side by at least about 0.1 nm, for example, in about 24 hours, that is, in a relatively short time, and the center wavelength of the optical transmission can be effectively compensated.

Also, in the planar lightwave circuit of the invention, by adopting the method for compensating the center wavelength of the optical transmission in the planar lightwave circuit described above, the planar lightwave circuit whose center wavelength of the optical transmission is compensated to be substantially a predetermined target wavelength is obtained.

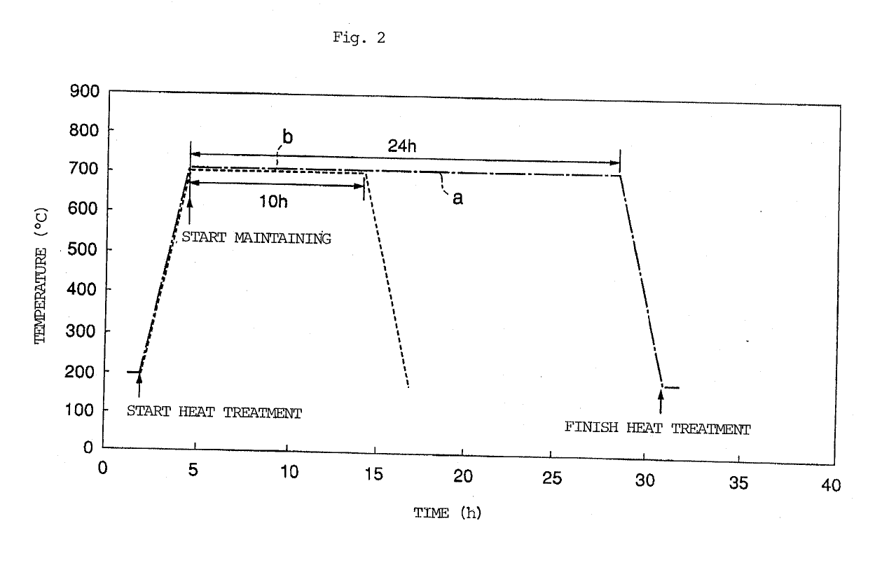

FIG. 2 is a graph showing examples of patterns of heat treatment temperatures. Referring to FIG. 2, the temperature in a furnace increases to the first set temperature (200° C. in this example), which is at least approximately a room temperature and at most approximately 500° C. Then, a planar lightwave circuit is put in the furnace. Then, the temperature in the furnace increases to the second set temperature (700° C. in this example), which is at least approximately 500° C. and at most approximately 900° C. The temperature is maintained at the second set temperature for the predetermined retention time. Thereafter, the temperature is lowered to a third set temperature (200° C. in the example), which is at least approximately a room temperature and at most approximately 500° C.

Incidentally, in a first example described below, the predetermined period of time during which the temperature is maintained at the second set temperature was 24 hours as indicated by a characteristic line (a) shown by a phantom line. In a second example, the predetermined period of time is 10 hours as indicated by a characteristic line (b) in a dotted line. Also, both the rate of increasing the temperature from the first set temperature to the second set temperature and the rate of lowering the temperature from the second set temperature to the third set temperature were about 5° C./min.

The inventors conducted the following studies and experiments to determine the aforementioned heat treatment in the embodiments. Firstly, a plurality of chips of the arrayed waveguide grating were manufactured, and the center wavelength of the optical transmission of the arrayed waveguide grating was measured at the room temperature (25° C., for example).

Thereafter, the heat treatment shown in FIG. 3 was applied to the chips of the arrayed waveguide grating. In the heat treatment temperature pattern shown in FIG. 3, both the first set temperature (A) and the second set temperature (C) were 200° C., and both the rate of increasing the temperature from the first set temperature (A) to the second set temperature (B) and the rate of lowering the temperature from the second set temperature (B) to the third set temperature (C) were 5° C./min.

Then, in order to determine the range of the second set temperature, plural temperatures were selected as the second set temperature for testing. The plural temperatures were 400° C., 450° C., 500° C., . . . , 900° C., 950° C. and 1000° C., namely, from 400° C. to 1000° C. with an interval of 50° C. After the heat treatment described above, the center wavelength of the optical transmission of each arrayed waveguide grating was measured at the room temperature.

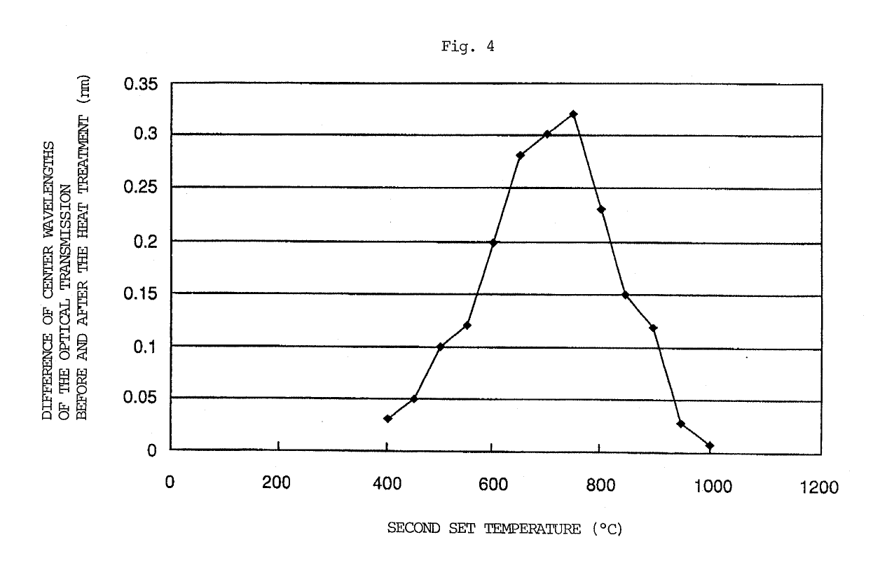

FIG. 4 shows the relationship between the second set temperature and a difference of the center wavelengths of the optical transmission before and after the heat treatment. The difference of the center wavelengths of the optical transmission is defined as follows: (the difference of the center wavelengths)=(center wavelength of the optical transmission after the heat treatment)−(center wavelength of the optical transmission before the heat treatment).

In view of FIG. 4, the present inventors found that if the second set temperature is at least approximately 500° C. and at most approximately 900° C. and the arrayed waveguide grating is kept in that temperature for about 24 hours, the center wavelength of the optical transmission in the arrayed waveguide grating is changed to the longer wavelength side by about 0.1 nm. Therefore, in the embodiment according to the present invention, the second set temperature is at least approximately 500° C. and at most approximately 900° C.

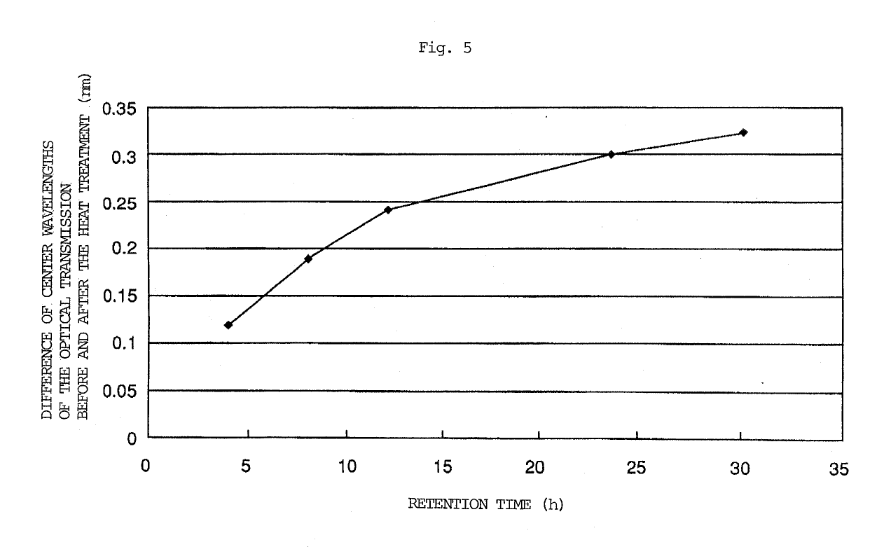

Also, in order to determine the retention time, plural retention times, 4 hour, 8 hour, 12 hour, 24 hour and 30 hour, were selected for testing. Each arrayed waveguide grating chip was kept at the second temperature of 700° C. for each retention time. FIG. 5 shows the relationship between the retention time and the difference of the center wavelengths of the optical transmission before and after the heat treatment. As shown in FIG. 5, as the retention time increases, the amount of change in the center wavelength of the optical transmission toward the longer wavelength side increases.

Based on the aforementioned data, the present inventors found that the center wavelength of the optical transmission in the arrayed waveguide grating changes to the longer wavelength side by a predetermined amount if the second set temperature and the retention time are adequately determined. Thus, in the embodiment, the heat treatments with temperature patterns as shown by the characteristic lines (a), (b) in FIG. 2, as described above, are carried out.

In the embodiment of the invention, as the first example, heat treatment according to the temperature pattern shown by the characteristic line (a) was applied to the chip of the arrayed waveguide grating. Namely, in the heat treatment of the first example, both the first set temperature and the third set temperature were set at 200° C., and the second set temperature were set at 700° C. Also, the retention time for retaining or holding the chip at the second set temperature was set to be 24 hours.

As a result, the center wavelength of the optical transmission in the arrayed waveguide grating, which had been 1554.6 nm before the heat treatment, was changed to be 1554.93 nm. The center wavelength of 1554.93 nm is within the range of ±0.003 nm of the target wavelength (1554.940 nm).

Also, as the second example, heat treatment according to the temperature pattern shown by the characteristic line (b) was applied to the chip of the arrayed waveguide grating. Namely, in the heat treatment of the second example, both the first set temperature and the third set temperature were set at 200° C., and the second set temperature were set at 700° C. Also, the retention time for retaining or holding the chip at the second set temperature was set to be 10 hours. As a result, the center wavelength of the optical transmission in the arrayed waveguide grating, which had been 1554.75 nm before the heat treatment, was changed to be 1554.96 nm after the heat treatment. The center wavelength of 1554.96 nm is within the range of ±0.03 nm of the target wavelength (1554.940 nm).

According to the embodiment of the present invention, by conducting the heat treatment having a relatively short duration according to the heat treatment patterns shown in FIG. 2, the center wavelength of the optical transmission of the arrayed waveguide grating is compensated to be substantially a target wavelength. Therefore, the manufacturing yield of the arrayed waveguide grating can be improved, and cost of the arrayed waveguide grating can be lowered.

Also, according to the embodiment of the present invention, both the temperature at the start of the heat treatment and the temperature at the end of the heat treatment are set at 200° C., so that there is no such danger that occurs when the chip of the arrayed waveguide grating is placed in or taken out from the heat treat furnace. Therefore, the heat treatment can be conducted safely.

The present invention is not limited to the aforementioned embodiment, and can be modified adequately. For example, although both the first set temperature and the third set temperature are set at 200° C. and the second set temperature is set at 700° C. in the method for compensating the center wavelength of the optical transmission in the planar lightwave circuit in the embodiment, the first set temperature and the third set temperature may be set at any temperature which is at least approximately a room temperature and at most approximately 500° C., and may be the same temperature, or different temperatures.

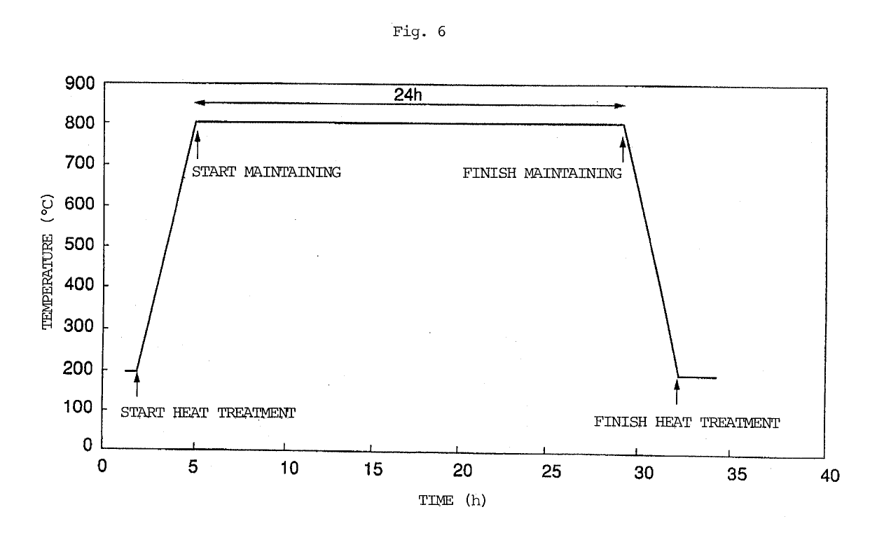

Also, the second set temperature may be set at any temperature which is at least approximately 500° C. and at most approximately 900° C. The predetermined retention time may be adequately set. As an example, FIG. 6 shows an example of a heat treatment temperature pattern in which the second set temperature is set at 800° C.

Further, in the heat treatment for the planar lightwave circuit such as the arrayed waveguide grating, the rate for increasing the temperature from the first set temperature to the second set temperature and the rate for lowering the temperature from the second set temperature to the third set temperature are not specifically limited, and may be modified adequately.

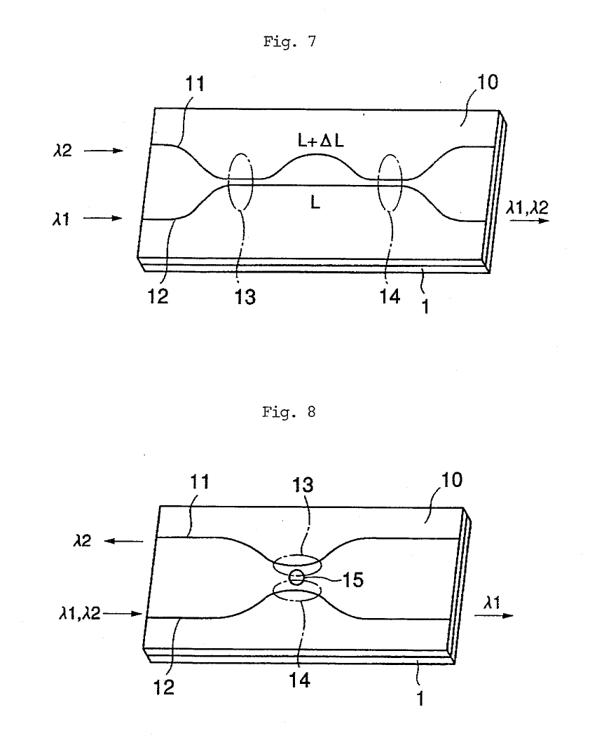

Still further, although the arrayed waveguide grating is used as the planar lightwave circuit in the embodiment, the present invention may be applied to various types of the planar lightwave circuits. For example, the present invention may be applied to the Mach-Zehnder interferometer shown in FIG. 7. Referring to FIG. 7, a silica-based glass waveguide forming region 10 is formed on a substrate 1 made of silicon or the like. In this waveguide pattern, first and second optical waveguides 11 and 12 are arranged side by side and spaced away from each other with an interval or span therebetween. A plurality of directional couplers (coupling portions; first and second directional couplers in this example) 13 and 14, in which the optical waveguides 11 and 12 are closely provided to each other, are formed with a space therebetween in a longitudinal direction of the waveguide. The length of the first optical waveguide 11 between the first and second directional couplers (13 and 14) and the length of the second optical waveguide 12 between the first and second directional couplers (13 and 14) are different. The waveguide region sandwiched between the adjacent directional couplers 13 and 14 constitutes a phase section, and the directional couplers and the phase section has a function for demultiplexing a signal light or multiplexing a plurality of signal lights.

Furthermore, for example, the present invention may be applied to a ring resonator shown in FIG. 8. Referring to FIG. 8, a silica glass waveguide forming region 10 is formed on a substrate 1 made of silicon or the like. In this waveguide pattern, two optical waveguides 11 and 12 are arranged with a space therebetween. A ring-shaped optical waveguide 15 is formed between these optical wave guides 11 and 12. Also, the waveguide pattern includes directional couplers 13 and 14. The directional coupler 13 is formed by closely providing the optical waveguides 11 and 15. The directional coupler 14 is formed by closely providing the optical waveguides 12 and 15. In the ring resonator, the ring-shaped optical waveguide 15 sandwiched between the directional couplers 13 and 14 constitutes a phase section. The directional couplers and the phase section has a function for demultiplexing a signal light or multiplexing a plurality of signal lights.

In the method for compensating the center wavelength of the optical transmission in the planar lightwave circuit according to the embodiment of the present invention, the center wavelength of the optical transmission in the planar lightwave wavelength such as the arrayed waveguide grating may be adjusted to the longer wavelength side by at least about 0.1 nm. Accordingly, the compensation of the center wavelength of the optical transmission can be effectively conducted. Also, since the temperature in the furnace when the planar lightwave circuit is put in and removed from the heat treat furnace is set at 500° C. or less, the workability can be improved, and the operations of conducting the method can be safely conducted.

Furthermore, according to the embodiment of the present invention, the center wavelength of the optical transmission in a planar lightwave circuit may be compensated to be substantially a target wavelength.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A method for compensating a center wavelength of optical transmission of a planar lightwave circuit, comprising:
heating the planar lightwave circuit from a first set temperature to a second set temperature, the first set temperature being at least approximately a room temperature and at most approximately 500° C., the second set temperature being at least approximately 500° C. and at most approximately 900° C.;
maintaining the planar lightwave circuit at the second set temperature for a predetermined retention time; and
cooling the planar lightwave circuit from the second set temperature to a third set temperature, the third set temperature being at least approximately a room temperature and at most approximately 500° C.

2. A method according to claim 1, wherein the planar lightwave circuit is heated from the first set temperature to the second set temperature in a rate of approximately 5° C./min.

3. A method according to claim 1, wherein the planar lightwave circuit is cooled from the second set temperature to the third set temperature in a rate of approximately 5° C./min.

4. A method according to claim 1, wherein the second set temperature is at least approximately 600° C. and at most approximately 850° C.

5. A method according to claim 1, wherein the predetermined retention time is at least about 5 hours.

6. A method according to claim 1, wherein the first set temperature is different from the third set temperature.

7. A method according to claim 1, wherein the first set temperature is substantially equal to the third set temperature.

8. A method according to claim 1, wherein the planar lightwave circuit is one of an arrayed waveguide grating, a Mach-Zehnder interferometer and a ring resonator.

9. A method for manufacturing a planar lightwave circuit, comprising:
forming a waveguide forming region on a substrate;
heating the waveguide forming region and the substrate from a first set temperature to a second set temperature, the first set temperature being at least approximately a room temperature and at most approximately 500° C., the second set temperature being at least approximately 500° C. and at most approximately 900° C.;
maintaining the waveguide forming region and the substrate at the second set temperature for a predetermined retention time; and
cooling the waveguide forming region and the substrate from the second set temperature to a third set temperature, the third set temperature being at least approximately a room temperature and at most approximately 500° C.

10. A method according to claim 9, wherein the waveguide forming region and the substrate are heated from the first set temperature to the second set temperature in a rate of approximately 5° C./min.

11. A method according to claim 9, wherein the waveguide forming region and the substrate are cooled from the second set temperature to the third set temperature in a rate of approximately 5° C./min.

12. A method according to claim 9, wherein the second set temperature is at least approximately 600° C. and at most approximately 850° C.

13. A method according to claim 9, wherein the predetermined retention time is at least about 5 hours.

14. A method according to claim 9, wherein the first set temperature is different from the third set temperature.

15. A method according to claim 9, wherein the first set temperature is substantially equal to the third set temperature.

16. A method according to claim 9, wherein the planar lightwave circuit is one of an arrayed waveguide grating, a Mach-Zehnder interferometer and a ring resonator.

17. A planar lightwave circuit comprising:
a substrate; and
a waveguide forming region formed on the substrate, the substrate and the waveguide forming region being constructed such that the substrate and the waveguide forming region are heated from a first set temperature to a second set temperature, maintained at the second set temperature for a predetermined retention time, and cooled from the second set temperature to a third set temperature, the first set temperature being at least approximately a room temperature and at most approximately 500° C., the second set temperature being at least approximately 500° C. and at most approximately 900° C., the third set temperature being at least approximately a room temperature and at most approximately 500° C.

18. A planar lightwave circuit according to claim 17, wherein the waveguide forming region comprises,
at least one first optical waveguide,
a first slab waveguide,
an arrayed waveguide having a plurality of channel waveguides and connected to said at least one first optical waveguide via said first slab waveguide,
a second slab waveguide, and
a plurality of second optical waveguides connected to said arrayed waveguide via said second slab waveguide.

19. A planar lightwave circuit according to claim 17, wherein the waveguide forming region comprises,
a first optical waveguide,
a second optical waveguide,
a first coupling portion in which the first and second optical waveguides are closely provided to each other, and
a second coupling portion in which the first and second optical waveguides are closely provided to each other, the first and second coupling portions being provided such that a length of the first optical waveguide between the first and second coupling portions and a length of the second optical waveguide between the first and second coupling portions are different.

20. A planar lightwave circuit according to claim 17, wherein the waveguide forming region comprises,
a first optical waveguide,
a second optical waveguide,
a ring-shaped optical waveguide formed between the first and second optical waveguides,
a first coupling portion in which the first optical waveguide and the ring-shaped optical waveguide are closely provided to each other, and
a second coupling portion in which the second optical waveguide and the ring-shaped optical waveguide are closely provided to each other.
